(19) United States
(12) Patent Application Publication
(10) Pub. No.: US 2013/0340278 A1
(43) Pub. Date: Dec. 26, 2013

(54) METHOD OF OPERATING A HEAT PUMP DRYER AND HEAT PUMP DRYER

(71) Applicants: Sergio Pillot, Pasiano di Pordenone (PN) (IT); Stefano Zandona', Vittorio Veneto (TV) (IT)

(72) Inventors: Sergio Pillot, Pasiano di Pordenone (PN) (IT); Stefano Zandona', Vittorio Veneto (TV) (IT)

(73) Assignee: ELECTROLUX HOME PRODUCTS CORPORATION N.V., Brussels (BE)

(21) Appl. No.: 13/990,940

(22) PCT Filed: Nov. 30, 2011
(86) PCT No.: PCT/EP11/71413

§ 371 Date: Sep. 11, 2013

(30) Foreign Application Priority Data
Dec. 2, 2010 (EP) 10193491.7

(51) Int. Cl. F26B 23/00

(52) U.S. Cl. CPC F26B 23/001
USPC 34/524; 34/86

(57) ABSTRACT

Heat pump dryer (1) comprising a process air circuit and a heat pump unit (5) having a primary refrigerant evaporator (6) for cooling process air (4) and a primary refrigerant condenser (7) for heating process air (4), further comprising either—an auxiliary refrigerant evaporator (16) connected between the primary refrigerant evaporator (6) and a compressor (8) of the heat pump unit (5) and an auxiliary refrigerant condenser (17) connected between the primary refrigerant condenser (7) and refrigerant expansion means (14), both arranged outside the process air circuit or—an auxiliary heat exchanger (27) arranged outside the process air circuit wherein the auxiliary heat exchanger (27) is a dual mode heat exchanger operable in refrigerant evaporator mode or in refrigerant condenser mode.

The present application is directed to a method of operating a heat pump dryer and a heat pump dryer.

Heat pump dryers and respective methods of operating the same are known for example from EP 0 999 302 B1, EP 1 884 586 A2 and US 2005/0066538. In tumble dryers, heated and dry process air is guided through wet clothing placed in a drying drum. The heated and dry process air absorbs moisture and thereby dries the clothing. After that, the process air is dehumidified, reheated and recirculated through the dryer drum, and so on.

The known heat pump dryers use a primary heat pump unit for dehumidification and reheating. The primary heat pump unit comprises a primary refrigerant evaporator for cooling and dehumidification of process air and a primary refrigerant condenser for reheating process air.

With the known e dryers, there is provided an auxiliary heat exchanger, in order to optimise dehumidification and reheating. In particular the heat-up phase can be shortened and, as the case may be, excess heat can be removed. It is known to use a fan to impinge an air stream, an ambient air stream for example, at the auxiliary heat exchanger thereby further optimising the drying process.

Albeit the known heat pump tumble dryers with auxiliary heat exchanger are more effective than ordinary heat pump tumble dryers, it is still desirable to further optimize the drying process, in particular in view of energy efficiency.

It is therefore an object of the present invention to provide a more efficient method of operating a heat pump dryer, preferably a heat pump tumble dryer, comprising an auxiliary heat exchanger. Further, a respective heat pump dryer shall be provided, preferably a heat pump tumble dryer.

This object is achieved by the independent claims. Embodiments of the invention result from dependent claims.

According the present invention there is provided a heat pump dryer comprising a process air circuit and a heat pump unit having a primary refrigerant evaporator for cooling process air and a primary refrigerant condenser for heating process air, wherein the heat pump dryer comprises either
an auxiliary refrigerant evaporator (16) connected between the primary refrigerant evaporator (6) and a compressor (8) of the heat pump unit(5) and an auxiliary refrigerant condenser (17) connected between the primary refrigerant condenser (7) and refrigerant expansion means (14), both arranged outside the process air circuit or
an auxiliary heat exchanger (27) arranged outside the process air circuit wherein the auxiliary heat exchanger (27) is a dual mode heat exchanger operable in refrigerant evaporator mode or in refrigerant condenser mode.

Preferably, wherein the heat pump dryer comprises at least one auxiliary fan adapted and arranged to impinge an airflow at the auxiliary refrigerant evaporator and at least one auxiliary fan adapted and arranged to impinge an airflow at the auxiliary refrigerant condenser and further comprising at least one sensor for detecting at least one physical parameter of the refrigerant and/or the process air and/or the ambient air around the location where the auxiliary refrigerant evaporator and/or the auxiliary refrigerant condenser are/is arranged and a control unit adapted and designed for evaluating the time development of the physical parameter and adapted and designed for activating/deactivating said auxiliary fans according to the evaluation of the time development of the physical parameter.

Preferably, the physical parameter is at least one of a refrigerant temperature, refrigerant pressure, process air temperature, process air humidity, temperature of the ambient air around location where the auxiliary refrigerant evaporator and/or the auxiliary refrigerant condenser are/is arranged.

Preferably, the refrigerant temperature is detected at the outlet of the primary refrigerant evaporator and/or at the outlet of the primary refrigerant condenser. Preferably, the process air temperature is detected at the inlet of a drying chamber of the heat pump dryer.

Preferably, the ambient air temperature is detected near or at the auxiliary refrigerant evaporator and/or near at the auxiliary refrigerant condenser.

Preferably, wherein the control unit is adapted to deactivate the auxiliary fan of the auxiliary refrigerant evaporator in an intermediate operational stage between a first and second operational stage, the control unit is adapted to activate the auxiliary fan of the auxiliary refrigerant condenser in a second operational stage.

Preferably, wherein the control unit is adapted to activate/deactivate the auxiliary fan of the auxiliary refrigerant evaporator according to the temperature difference between refrigerant and the ambient air around the location where the auxiliary refrigerant evaporator is arranged.

Preferably, the heat pump dryer comprises at least one sensor for detecting at least one physical parameter of the refrigerant and/or the process air and/or the ambient air around the location where the auxiliary heat exchanger is arranged and a control unit adapted and designed for evaluating the time development of the physical parameter and adapted and designed for switching the auxiliary heat exchanger between the evaporator mode and the condenser mode according to the evaluation of the time development of the physical parameter, wherein preferably the physical parameter is at least one of a refrigerant temperature, refrigerant pressure, process air temperature, process air humidity, temperature of the ambient air around the location where the auxiliary heat exchanger is arranged.

Preferably, the refrigerant temperature is detected at the outlet of the primary refrigerant evaporator and/or at the outlet of the primary refrigerant condenser.

Preferably, the process air temperature is detected at the inlet of a drying chamber of the heat pump tumble dryer.

Preferably, the air temperature is detected near or at the auxiliary heat exchanger.

Preferably, the control unit is adapted to switch the auxiliary heat exchanger between evaporator mode and condenser mode in response of at least one of
a temperature and/or pressure of the refrigerant,
a temperature and/or humidity of the process air (4),
a temperature of ambient air near or at the auxiliary heat exchanger (27),
a temperature difference between ambient air temperature near or at the auxiliary heat exchanger (27) and refrigerant temperature, preferably detected near or at the primary evaporator (16).

Preferably, the heat pump dryer comprises commutating means, preferably comprising one or more valves, adapted to switch the auxiliary heat exchanger between evaporator mode and condenser mode.

Preferably, the control unit is adapted to operate the commutating means according to the evaluation of the time development of the physical parameter.

Preferably, the auxiliary heat exchanger is connected via ducting, and valves, with the primary refrigerant evaporator, the primary refrigerant condenser and a compressor.

Preferably, the heat pump dryer comprises at least one auxiliary fan adapted and arranged to impinge an airflow at the auxiliary heat exchanger and further comprising at least one sensor for detecting at least one physical parameter of the refrigerant and/or the process air and/or the ambient air of the location where the auxiliary heat exchanger is arranged and a control unit adapted and designed for evaluating the time development of the physical parameter and adapted and designed for activating/deactivating said auxiliary fan according to the evaluation of the time development of the physical parameter, wherein preferably the physical parameter is at least one of a refrigerant temperature, refrigerant pressure, process air temperature, process air humidity, ambient air temperature of the location where the auxiliary heat exchanger is arranged.

Preferably the control unit is activates/deactivates the auxiliary fan of the auxiliary heat exchanger according to at least one of
a temperature difference between refrigerant and air near or at the auxiliary refrigerant evaporator or auxiliary refrigerant condenser, the refrigerant temperature preferably being measured near or at the primary refrigerant evaporator,
an air temperature near or at the auxiliary refrigerant evaporator, auxiliary refrigerant condenser, auxiliary fan and/or a waste heat generating component of the heat pump tumble dryer,
a temperature of the refrigerant and/or a pressure of the refrigerant, both preferably measured near or at a refrigerant outlet of the primary evaporator or primary condenser,
a temperature of refrigerant near or at an refrigerant outlet or inlet of the auxiliary refrigerant evaporator or auxiliary refrigerant condenser,
a temperature difference between refrigerant and air near or at the auxiliary refrigerant evaporator,
a temperature of the process air and/or humidity of the process air, both preferably near or at a process air inlet of a drum of the heat pump tumble dryer.

Preferably, the control unit activates the auxiliary fan of the auxiliary heat exchanger if the temperature of the respective fan air stream is at least above the temperature of the refrigerant at the refrigerant outlet of the primary refrigerant evaporator or inlet of the auxiliary heat exchanger, and wherein the control unit deactivates the auxiliary fan of the auxiliary heat exchanger if the temperature of the fan air stream is at least below the temperature of the refrigerant at the refrigerant outlet of the primary refrigerant evaporator.

According to one aspect, there is provided a method of operating a heat pump tumble dryer, which heat pump tumble dryer comprises a primary heat pump unit with at least one primary refrigerant evaporator for cooling process air, at least one primary refrigerant condenser for heating process air, at least one auxiliary heat exchanger arranged outside the process air circuit and connected or connectable between at least one of the at least one primary refrigerant evaporator and at least one of the at least one primary refrigerant condenser, and at least one auxiliary fan adapted to impinge an air stream at a respective one of the at least one auxiliary heat exchanger.

The at least one auxiliary fan can be activated and deactivated by a refrigerant cycle control unit using selected temperature, humidity and/or pressure values of at least one of the refrigerant and process air.

The invention is inter alia based on the finding that the efficiency of such a heat pump tumble dryer can be improved if the temperature and/or pressure value is selected from the group comprising: the temperature of the refrigerant and a pressure of the refrigerant, both preferably measured near or at a refrigerant outlet or inlet of the primary evaporator or primary condenser, the temperature of refrigerant near or at an refrigerant outlet or inlet of the auxiliary heat exchanger, an air temperature near or at the auxiliary heat exchanger, in particular the temperature of the air stream impinging at the at least one auxiliary heat exchanger, the temperature difference between refrigerant near or at the refrigerant outlet or inlet of the primary evaporator or primary condenser and the air stream, a temperature difference between refrigerant and air near or at the auxiliary heat exchanger, preferably being an auxiliary evaporator, the temperature of the process air and humidity of the process air, both preferably near or at a process air inlet of a drum of the heat pump tumble dryer.

The auxiliary heat exchanger may be an auxiliary refrigerant evaporator, which can be connected between the primary refrigerant evaporator and a compressor operating in the auxiliary refrigerant circuit. Here, the at least one auxiliary fan may be adapted to impinge an air stream at the auxiliary refrigerant evaporator.

It is also possible that the at least one auxiliary fan is activated and deactivated according to at least one of
a temperature difference between refrigerant and air near or at the auxiliary refrigerant evaporator, the temperature preferably being measured near or at the primary refrigerant evaporator and
an air temperature near or at the auxiliary refrigerant evaporator.

It is to be noted that “an air temperature near or at the auxiliary refrigerant evaporator or the auxiliary heat exchanger” indicates the temperature of the ambient air around the location/position/place where the auxiliary refrigerant evaporator or the auxiliary heat exchanger is arranged at the heat pump dryer.

Preferably, the auxiliary refrigerant evaporator or the auxiliary heat exchanger is arranged inside the external casing of the heat pump dryer and preferably it is provided at the basement of the heat pump dryer.

Preferably, respective temperature and pressure values used by the refrigerant cycle control unit are measured by at least one of a temperature sensor and pressure sensor of the heat pump tumble dryer, arranged at respective locations. The temperature sensor and pressure sensor may be of any known type. In particular, so called NTC (negative temperature coefficient) or also PTC (positive temperature coefficient) temperature sensors or other may be used.

At least one of the at least one auxiliary fan can for example be activated if the temperature of the refrigerant near or at an outlet of the primary refrigerant evaporator or near an inlet of the auxiliary heat exchanger is at least below a first preset temperature, and wherein the at least one fan is deactivated if the temperature of the refrigerant near or at an outlet of the primary refrigerant evaporator or near an inlet of the auxiliary heat exchanger is at least above the first preset temperature. This is of particular advantage, if the auxiliary heat exchanger is operated as an auxiliary refrigerant evaporator, as in this case heat of an air stream of ambient air and/or waste heat augmented air of components, in particular ambient air heated up by heat released from components, in particular electric and electronic components, of the dryer, such as a motor and the like or others, impinging at the auxiliary evaporator for example, can be efficiently exploited, i.e. used to speed-up the heat-up phase.

In particular, the fan can be activated if the respective fan air stream is at least above, i.e. above and/or equal, the temperature of the refrigerant at the outlet of the primary refrigerant evaporator. Here, the first preset temperature is the temperature of ambient air and/or waste heat augmented air of components, impinging at the auxiliary heat exchanger. In the present case, the auxiliary heat exchanger preferably is an auxiliary refrigerant evaporator. The at least one fan is deactivated if the temperature of the fan air stream is at least below the temperature of the refrigerant at the refrigerant outlet of the primary evaporator.

In an embodiment, at least one of the at least one auxiliary fan is deactivated if a temperature of refrigerant near or at an outlet of the primary or auxiliary heat exchanger is at least below a second preset temperature, and wherein the at least one auxiliary fan is activated if the temperature of refrigerant near or at an outlet of the primary or auxiliary heat exchanger is at least above a second preset temperature. Such an operational mode is of particular advantage if the auxiliary heat exchanger is operated as an auxiliary refrigerant condenser. Here it is possible remove excessive heat from the heat pump tumble dryer by cooling the auxiliary refrigerant condenser.

As already indicated, embodiments of the proposed method provide that at least one of the at least one auxiliary heat exchanger is operated as an auxiliary refrigerant evaporator and/or an auxiliary refrigerant condenser.

By using the auxiliary heat exchanger as auxiliary refrigerant evaporator coupled to the heat pump unit, the initial heat up phase of the heat pump unit can be shortened. Using the auxiliary heat exchanger as auxiliary refrigerant condenser excessive heat probably arising in the course of operating the heat pump tumble dryer can be removed. Hence, the performance of the heat pump tumble dryer can be improved.

In an embodiment, at least one of the auxiliary heat exchanger is operated in a dual mode, i.e. in a first operational cycle, as an auxiliary refrigerant evaporator and, in a second operational cycle, as an auxiliary refrigerant condenser. Here, a commutator, preferably comprising one or more valves, may be used to switch between evaporator and condenser mode. The evaporator mode can be used in the initial operational phase of the heat pump tumble dryer in order to speed-up the heat-up process. The condenser mode can be used in a later stage to remove excessive heat.

Switching between first and second operational modes can be carried out in response of at least one of:
a temperature and/or pressure of the refrigerant,
a temperature and/or humidity of the process air,
a temperature of ambient air near or at the auxiliary heat exchanger,
a temperature difference between ambient air temperature near or at the auxiliary heat exchanger and refrigerant temperature, preferably detected near or at the primary evaporator.

However, it is also possible that at least one of the at least one auxiliary heat exchanger is operated as an auxiliary refrigerant evaporator, and that at least one of the at least one auxiliary heat exchanger is operated as an auxiliary refrigerant condenser. In this case, both an auxiliary refrigerant evaporator and auxiliary refrigerant condenser are provided.

As already indicated above, at least one of ambient air and waste heat augmented air from components of the heat pump tumble dryer can be impinged at at least one of the at least one auxiliary heat exchanger by at least one of the at least one fan. Ambient air colder than condenser refrigerant can be impinged at the auxiliary refrigerant condenser in order to effectively remove excessive heat generated in the course of operating the heat pump tumble dryer. Ambient air and/or waste heat augmented air from components of the heat pump tumble dryer, having a temperature above evaporator refrigerant can be impinged at the auxiliary refrigerant evaporator in order to optimise heating-up in the initial operational phase of the heat pump tumble dryer.

As can be seen, ambient air as well as waste heat augmented air of components, such as motors and other electronic components, of the heat pump tumble dryer can be impinged in a first air stream at the auxiliary refrigerant evaporator by at least one first auxiliary fan. Further, ambient air can be impinged in a second air stream at the auxiliary refrigerant condenser by at least one second auxiliary fan.

In one embodiment there may be provided that the at least one auxiliary heat exchanger is deactivated by the controller unit in an intermediate operational stage between a first and second operational stage in which at least one of the at least one auxiliary heat exchanger is activated respectively. The intermediate phase can be the time interval between the initial phase in which an auxiliary heat exchanger is used for accelerating heating-up and the phase in which an auxiliary heat exchanger is used for removing excessive heat from the heat pump tumble dryer system.

As can be seen, the proposed method allows to operate a heat pump tumble dryer comprising an auxiliary heat exchanger more efficiently.

According to a further aspect, a heat pump tumble dryer is provided which comprises a primary heat pump unit with at least one primary refrigerant evaporator for cooling process air and at least one primary refrigerant condenser for heating process air, at least one auxiliary heat exchanger arranged outside the process air circuit and connected or connectable between at least one of the at least one primary refrigerant evaporator and at least one of the at least one primary refrigerant condenser.

At least one heat exchanger may be implemented to be operated as an auxiliary refrigerant evaporator and at least one heat exchanger may be implemented to be operated as an auxiliary refrigerant condenser.

The heat pump tumble dryer may further comprise at least one auxiliary fan adapted to impinge an air stream at a respective one of the at least one auxiliary heat exchanger. The fan may be arranged and adapted to impinge at least one of ambient air and waste heat augmented air from components of the heat pump tumble dryer at at least one of the at least one auxiliary heat exchanger, in particular either at an auxiliary refrigerant evaporator or at an auxiliary refrigerant condenser. In particular it is possible that at least one auxiliary fan is adapted and arranged to impinge an airflow at the auxiliary refrigerant evaporator and at least one auxiliary fan is adapted and arranged to impinge an airflow at the auxiliary refrigerant condenser. One or several respective auxiliary fans may be provided in each case.

The proposed heat pump tumble dryer may further comprise a refrigerant cycle control unit which is adapted and designed for operating the heat pump tumble dryer according to the proposed method or any embodiment thereof.

As to advantages and advantageous effects of the heat pump tumble dryer, reference is made to the discussion in connection with the proposed method or any embodiment thereof. The heat pump tumble dryer may comprise respective temperature sensors, in particular NTC and PTC temperature sensors, and respective humidity and pressure sensors, connected to the refrigerant cycle control unit and adapted and located to measure respective temperature, humidity and pressure values. Respective temperature, pressure and humidity values can be used to operate the at least one auxiliary fan. The calculation of temperature differences or other operations in connection with respective temperature and pressure values may be executed by the cycle control unit. Further, the at least one auxiliary heat exchanger may be at least one of an auxiliary refrigerant evaporator and auxiliary refrigerant condenser. Respective auxiliary fans, and, as the case may be, associated ducting and the like may be provided and arranged such that respective air streams can be adequately impinged at the at least one auxiliary heat exchanger. Air for generating respective air streams may be taken from the outside of the heat pump tumble dryer via front, back or side openings provided in the heat pump tumble dryer housing. It is also possible that air for generating respective air streams is at least partially taken from locations inside the heat pump tumble dryer housing.

A heat pump tumble dryer may comprise a heat pump unit with a primary refrigerant evaporator for cooling process air, a primary refrigerant condenser for heating process air, and further comprising at least one auxiliary refrigerant evaporator and at least one auxiliary refrigerant condenser respectively connected between the primary refrigerant evaporator and the primary refrigerant condenser or a compressor operating in the auxiliary refrigerant cycle. In this case, the heat pump tumble dryer comprises both an auxiliary refrigerant evaporator and auxiliary condenser that may be operated independently from each other. This has the advantage that both the heat-up phase and the process of removing excess heat can be optimized independent from each other in a more flexible way, in particular with respect to energetic considerations. The heat-up phase can be optimized by operating the auxiliary refrigerant evaporator in an initial operational stage for example. The auxiliary refrigerant condenser may be operated in an advanced stage or phase in which removal of excess heat from the refrigerant is required for keeping optimal refrigerant working conditions.

In the case that both an auxiliary refrigerant evaporator and auxiliary refrigerant condenser shall be available, it is possible that at least one auxiliary heat exchanger is a dual mode heat exchanger which is operable in a heat evaporator and a heat condenser mode. In this case it is possible to switch the heat exchanger from auxiliary evaporator mode to auxiliary condenser mode and vice versa according to respective needs, in particular in response or dependent on certain parameter values as described further above. Such parameter values may comprise temperature, pressure and/or humidity values of refrigerant, process air, ambient air.

The heat pump tumble dryer as proposed immediately beforehand may comprise a refrigerant cycle control unit adapted and designed for operating the heat pump tumble dryer according to the proposed method or any embodiment thereof. As to advantages and advantageous effects reference is made to the discussion further above.

The at least one auxiliary fan of the heat pump tumble dryer may be adapted to impinge at least one of ambient air and waste heat augmented air from components of the heat pump tumble dryer at least one of the at least one auxiliary heat exchanger.

In the case that at least one auxiliary heat exchanger is operated as an auxiliary refrigerant evaporator, a mutual arrangement of the auxiliary refrigerant evaporator, at least one auxiliary fan and a motor or other waste heat generating components of the heat pump tumble dryer with respect to an auxiliary fan airflow is at least one of:
the auxiliary fan, auxiliary refrigerant evaporator (16) and motor are arranged in series
the auxiliary fan is arranged between the motor and the auxiliary refrigerant evaporator,
the auxiliary refrigerant evaporator is arranged between the motor and the auxiliary fan.

It is possible and in some cases preferred, that the at least one auxiliary fan is adapted to suck in air from at least one of inside the cabinet or casing of the heat pump tumble dryer, outside the cabinet, in particular from a rear, front or bottom side of the heat pump tumble dryer.

Temperature sensors arranged outside the process air circuit and provided for measuring or detecting an air temperature may preferably be arranged near or at the auxiliary refrigerant evaporator. The measured temperatures may be used for controlling operation of the at least one auxiliary fan.

At least one of the at least one temperature sensor arranged outside the process air circuit may be arranged at least one of near or at the at least one auxiliary refrigerant evaporator, near or at the at least one auxiliary fan, between one of the at least one auxiliary refrigerant evaporator and at least one auxiliary fan, between waste heat generating components, in particular electric components, of the heat pump tumble dryer, and the at least one auxiliary fan, between waste heat generating components, in particular electric components, such as a motor of the heat pump tumble dryer, and the at least one auxiliary refrigerant evaporator.

As becomes obvious from the above discussion, the proposed method and heat pump tumble dryers are suitable for improving operational efficiency, in particular with respect to energetic aspects. In particular they are effective in speeding up the process of drying cloths in that the initial heat-up phase can be shortened. Further, it is possible to obtain or maintain optimal refrigerant working conditions in advanced operational stages, in that excess heat can be removed by an auxiliary condenser functionality.

Embodiments of the invention will now be described in connection with the annexed figures, in which

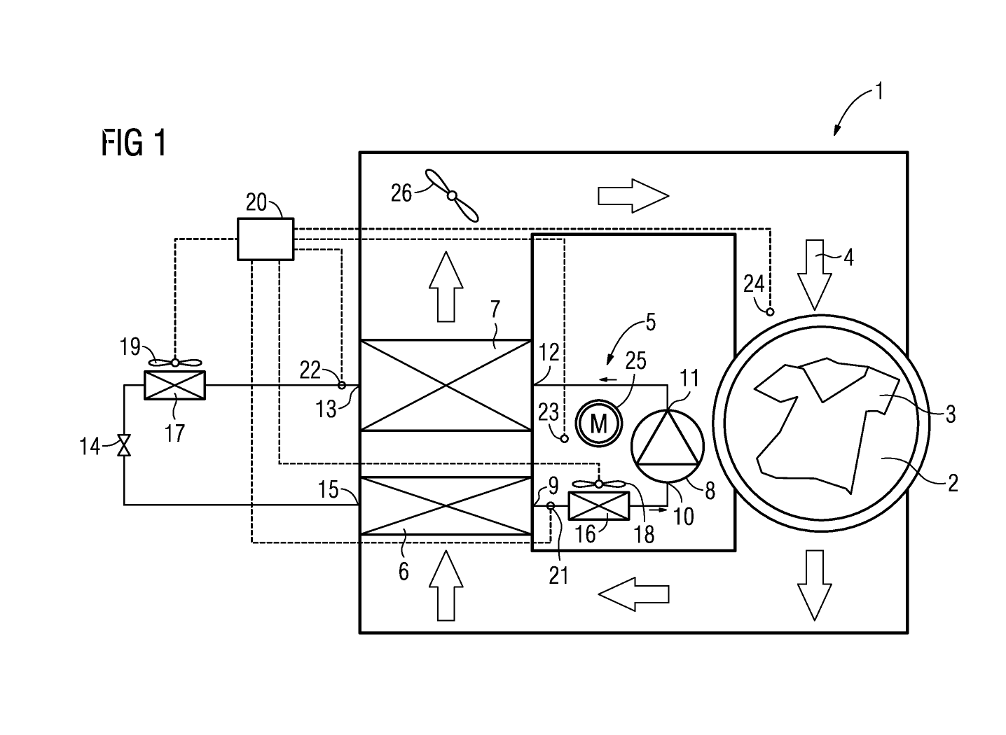

FIG. 1 schematically shows a comprehensive configuration of a heat pump tumble dryer;

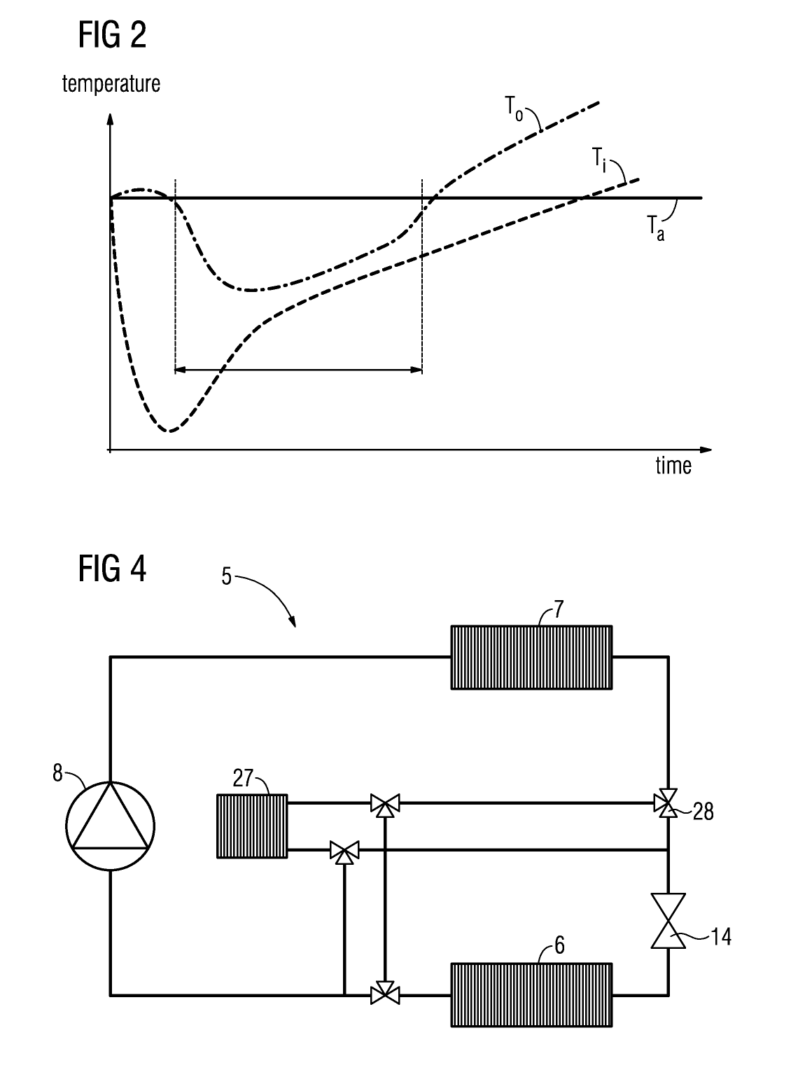

FIG. 2 diagrams refrigerant inlet and outlet temperatures in the heat-up phase;

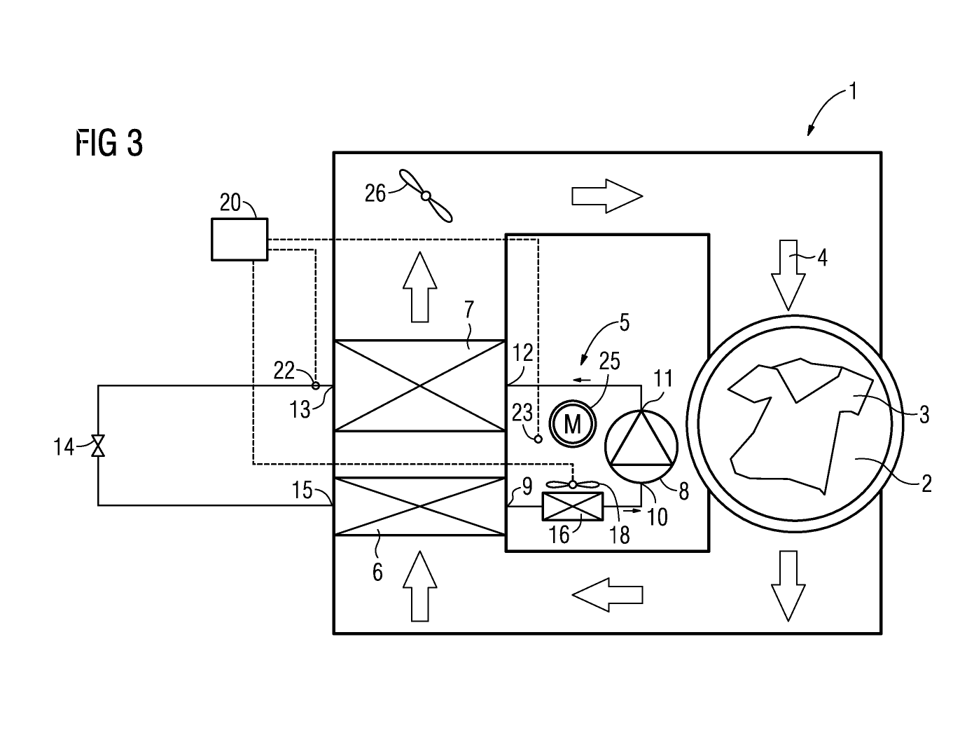

FIG. 3 schematically shows a second configuration of a heat pump tumble dryer;

FIG. 4 schematically shows a third configuration of a heat pump tumble dryer;

FIG. 5 shows a first operational mode of the third configuration shown in FIG. 4;

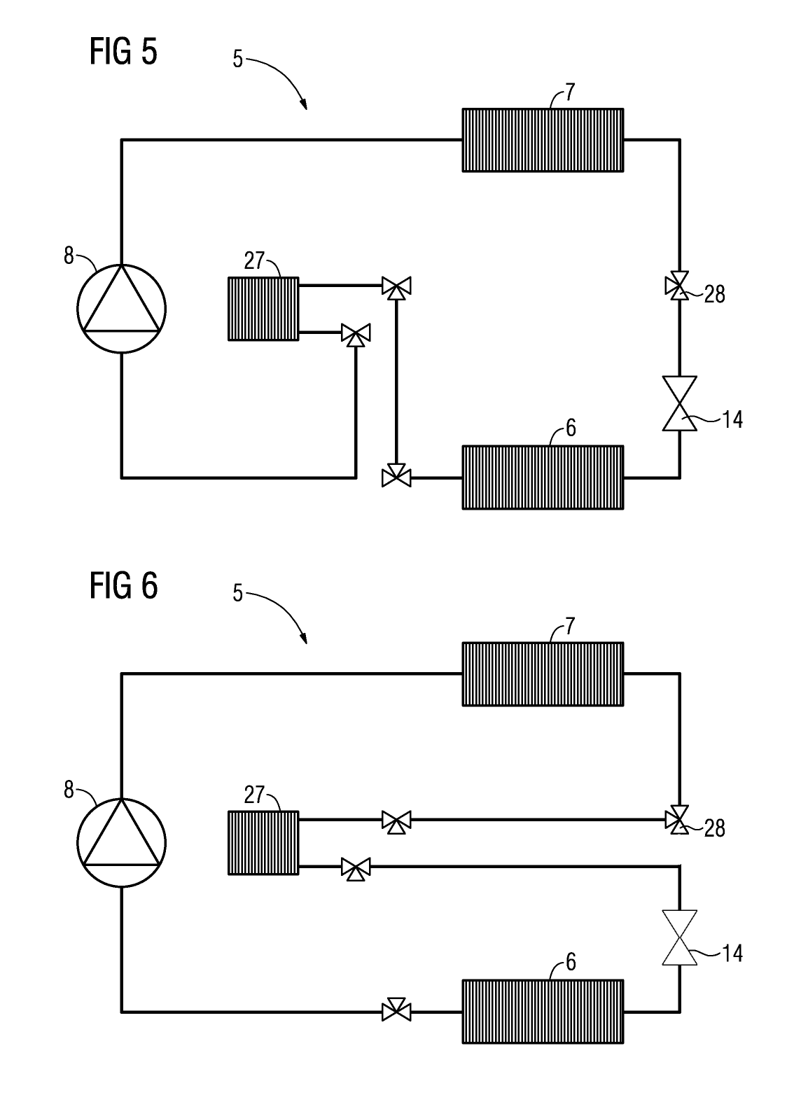

FIG. 6 shows a second operational mode of the third configuration shown in FIG. 4; and

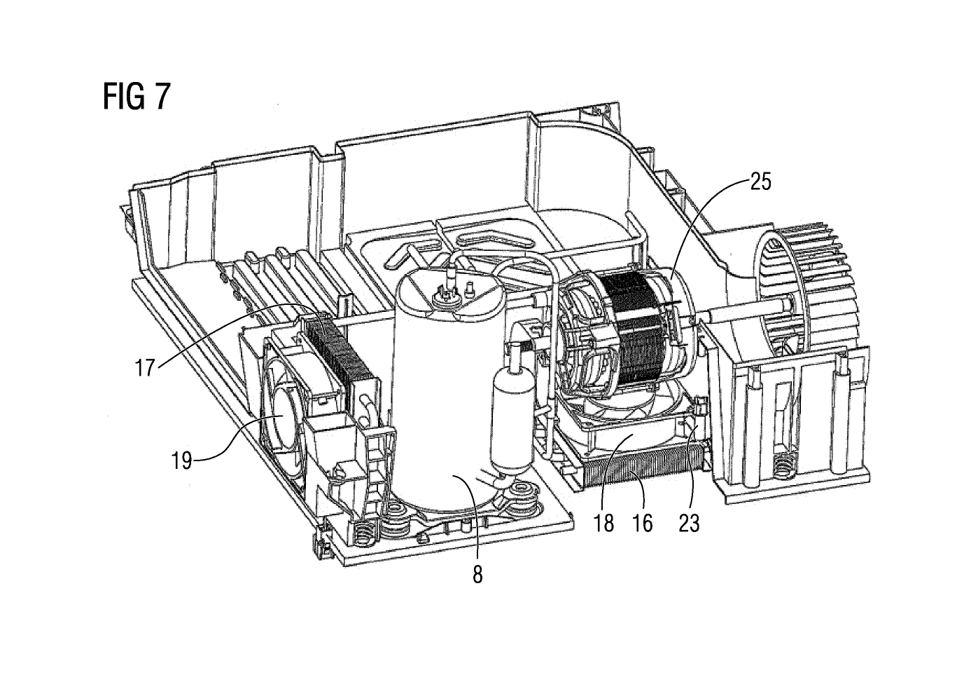

FIG. 7 shows an arrangement of certain components of the heat pump tumble dryer and in particularly the location/position/place where the auxiliary refrigerant evaporator is arranged at the heat pump dryer.

The following description of embodiments of a heat pump tumble dryer shall not be construed as limiting the scope of the invention. In particular, features jointly shown in any of the figures can be implemented alone or in any other combination as discussed further above.

If not otherwise stated like elements are denoted by like reference signs throughout the figures. The figures may not be true to scale, and scales of different figures may be different.

FIG. 1 schematically shows a comprehensive configuration of a heat pump dryer 1, preferably a heat pump tumble dryer. Comprehensive shall mean that the configuration shows more features and components than are necessary to implement the invention.

The heat pump dryer 1 comprises a drying chamber 2, preferably a rotatable drum, in which wet clothing 3 to be dried can be arranged. For drying clothing 3, process air 4 is circulated through a process air circuit comprising the drying chamber 2. In more detail, heated process air 4 with a comparative low relative humidity is fed into the drying drum 2 impinging at the wet clothing 3 and absorbing or withdrawing humidity of wet clothing 3.

Process air 4 having a comparatively high relative humidity leaves the drying drum 2 and is cooled down to remove humidity therefrom. After that, the process air 4 is reheated, thereby reducing its relative humidity, and is fed into the drying drum 2 again.

For dehumidification and reheating the process air 4, the heat pump tumble dryer 1 comprises a heat pump unit 5. The heat pump unit 5 comprises a primary refrigerant evaporator 6 and a primary refrigerant condenser 7. For drying clothing 3, the process air circuit further comprises the primary refrigerant evaporator 6 and the primary refrigerant condenser 7.

Further, the heat pump unit 5 comprises a compressor 8 interconnected between the primary refrigerant evaporator 6 and primary refrigerant condenser 7. In more detail, a primary refrigerant evaporator outlet 9 is connected to a compressor inlet 10. A compressor outlet 11 is connected to a primary refrigerant condenser inlet 12. A primary refrigerant condenser outlet 13 is connected via refrigerant expansion means such as throttling element 14, a capillary or an adjustable valve for example, to a primary refrigerant evaporator inlet 15. As such, the heat pump unit 5 described so far corresponds to an ordinary tumble dryer heat pump with which heat is transferred from the primary refrigerant evaporator 6 to the primary refrigerant condenser 7. In particular, refrigerant circulated in the heat pump unit closed circuit is cooled down at the primary refrigerant evaporator 6 and heated up at the primary refrigerant condenser 7.

The relatively low temperature at the primary refrigerant evaporator 6 is used to cool down, i.e. to dehumidify, the process air 4 having exited the drying drum 2. The relatively high temperature at the primary refrigerant condenser 7 is used to reheat the process air 4 to be fed to the drying drum 2.

The heat pump unit 5 further comprises two auxiliary heat exchangers, an auxiliary refrigerant evaporator 16 and an auxiliary refrigerant condenser 17 in the present case. Note that it is not mandatory that exactly two auxiliary heat exchangers are provided. Rather, the number of auxiliary refrigerant heat exchangers can be varied from one to nearly any arbitrary number.

The auxiliary refrigerant evaporator 16 is interposed between the primary refrigerant evaporator 6 and the compressor 8. The auxiliary refrigerant condenser 17 is interposed between the primary refrigerant condenser 7 and the primary refrigerant evaporator 6 downstream the primary refrigerant condenser 7 but upstream the throttling element 14. Note that the direction of refrigerant flow is indicated in FIG. 1 by small arrows. The auxiliary heat exchangers are arranged outside the process air circuit, i.e. that they are not impinged with process air 4.

The auxiliary refrigerant evaporator 16 serves to speed up heat transfer to the primary refrigerant condenser 7, i.e. to speed up the heat-up phase of the heat pump tumble dryer 1.

The auxiliary refrigerant condenser serves to remove excess heat from the refrigerant which may become relevant in advanced stages of tumble dryer operation. As can be seen, the purpose of the auxiliary heat exchangers is quite special. Therefore it is required to adequately and exactly operate the auxiliary heat exchangers, as provided and proposed herein, and to provide respective operational conditions.

In order to have a better control over the auxiliary heat exchangers, there are provided a first fan 18 and a second fan 19, which are adapted to impinge an air stream at the auxiliary refrigerant evaporator 16 and auxiliary refrigerant condenser 17, respectively.

It has been found by the inventors, that in view of energetic aspects it is of crucial importance to adequately control the first fan 18 and, if applicable, also the second fan 19 according to selected temperatures or pressures of the refrigerant and/or process air 4, measured at specific locations along the heat pump refrigerant circuit or process air circuit.

Therefore, the proposed heat pump tumble dryer further comprises a refrigerant cycle control unit 20 which is adapted and designed to control the first 18 and second fan 19 according to special temperature values as exemplarily set out further below. Note that also refrigerant pressure values or process air pressure values or process air humidity values may be used in order to control the first 18 and second fan 19. In general, all temperature and/or pressure values mentioned so far and further below may be used, in particular but not restricted to the temperature of the air where the auxiliary refrigerant evaporator 16 is arranged, and also the temperature difference between air where the auxiliary refrigerant evaporator is arranged and refrigerant, preferably detected near or at the primary refrigerant evaporator 6.

In order to measure respective temperature values, the cycle control unit 20 is connected to first 21 to fourth temperature sensors 24. Based on the temperature values, which are respectively denoted as first to fourth temperature values, the refrigerant cycle control unit 20 can activate and deactivate the first 18 and second fan 19 as follows:

The first temperature value measured with the first temperature sensor 21 and corresponding essentially to the refrigerant temperature between the primary refrigerant evaporator 6 and auxiliary refrigerant evaporator 16, can be used together with the temperature of the air stream impinging at the auxiliary refrigerant evaporator 6, i.e. the third temperature value. The first fan 18 can be activated, if the first temperature value is lower than the third temperature value. The first fan 18 can be deactivated again, if the first temperature value is higher than the third temperature value. In doing so, at least the initial heat-up phase of the heat-pump unit 5 can be accelerated. In particular, the first fan 18 can be kept activated up to the point in which the temperature of the air stream impinging at the auxiliary refrigerant evaporator 16 is about equal the temperature of the refrigerant at the auxiliary refrigerant evaporator 16, i.e. or in other words up to the point in which the first temperature value is about the same as the third temperature value. The first fan 18 shall be deactivated if the first temperature value is higher than the third temperature value as in this case a negative energetic balance may result.

In order to keep the temperature of the air stream impinging at the auxiliary refrigerant evaporator 16 or the auxiliary dual mode heat exchanger 27 on high levels as long as possible, it is advantageous to use waste heat augmented air from components of the heat pump tumble dryer 1. Such waste heat may for example be generated by at least one waste heat generating component of the heat pump tumble dryer 1 such as an electric device, an electronic device, a powered device, a passive device, an electric motor, a controller for varying the speed of an electric, an inverter for example. Using waste heat in such a way improves energetic efficiency of the heat pump tumble dryer 1.

For example, while in normal condition the temperature of the ambient air around the location where the auxiliary refrigerant evaporator 16 or the auxiliary dual mode heat exchanger 27 is arranged ranges from 20° C. to 23° C. (obviously if the heat pump dryer is placed outside the temperature may be different), in case of ambient air heated up by the heat released from the electric motor (for example), the ambient air temperature can range from 30° C. to 45° C. depending on the mutual arrangement of auxiliary refrigerant evaporator 16 or auxiliary dual mode heat exchanger 27, auxiliary fan 18, 19 and electric motor.

As it can be readily understood, this has beneficial effects during the initial operation of the heat pump dryer 1 by speeding up the warm up phase of the heat pump unit 5.

The first fan 18 can also or in the alternative be controlled in dependence of the fourth temperature value, i.e. the process air temperature at an entrance region to the drying drum 2. At comparatively low fourth temperature values, indicating that the heat pump tumble dryer 1 is still in the initial heat-up phase, the first fan 18 can be activated. As soon as the fourth temperature value reaches a given threshold indicative of normal operational conditions, the first fan 18 can be deactivated again.

Turning now to the second fan 19 impinging an air stream at the auxiliary refrigerant condenser 17, the second temperature value, i.e. the temperature of the refrigerant at an refrigerant outlet of the primary refrigerant condenser 7, is used. As already mentioned, the auxiliary refrigerant condenser 17 is provided for the purpose of removing or even preventing overheat in the refrigerant. Therefore, the second fan 19 is activated if the second temperature reaches or exceeds a preset overheat temperature level. In the case that the temperature lies or falls below that level, the second fan 19 can or shall be deactivated in order to obtain optimal operation and steady conditions, in particular with respect to energetic aspects.

For sake of completeness it shall be mentioned that the heat pump tumble dryer 1 comprises a third fan 26 adapted and designed for circulating the process air 4 within the heat pump tumble dryer 1.

FIG. 2 diagrams refrigerant evaporator inlet temperatures Tᵢ, refrigerant evaporator outlet temperatures Tₒ and ambient air temperature Tₐ versus operational time. The ambient air temperature Tₐ may be the temperature of ambient air of the area where the auxiliary refrigerant evaporator 16 is arranged with or without heating provided by electric or electronic components of the dryer 1. Under normal conditions, ambient air temperature Tₐ remains constant over time. In the heat up phase of the heat pump tumble dryer 1, the outlet temperature Tₒ first raises, then drops and finally raises again. The inlet temperature Tᵢ has a similar behaviour. Especially in the time interval, in which the outlet temperature Tₒ is below ambient air temperature Tₐ, which is indicated by a double arrow in FIG. 2, the auxiliary refrigerant evaporator 16 can effectively be used to shorten the heating-up phase of the heat pump tumble dryer 1.

FIG. 3 shows a different configuration, in which the auxiliary refrigerant condenser 17 and related components are left out. With the second configuration, only the second temperature value, i.e. the refrigerant temperature at the primary refrigerator condenser outlet 13, and the third temperature value, i.e. the temperature of the air stream impinged at the auxiliary refrigerant evaporator 16, are or can be used. In using these temperature values or probably only the third temperature value, the heat up phase can at least roughly be identified and the first fan 18 can be operated accordingly, in particular as described in connection with FIGS. 1 and 2. As can be seen, with the second configuration, the heat-up phase of the heat-pump tumble dryer 1 can be optimized.

FIG. 4 schematically shows a third configuration of a heat pump tumble dryer. For the sake of clarity, only components of the heat pump unit 5 are shown. The difference as compared to the first configuration is that the third configuration comprises an auxiliary dual mode heat exchanger 27 instead of the auxiliary refrigerant evaporator 16 and auxiliary refrigerant condenser 17. The dual mode heat exchanger can be operated as an auxiliary refrigerant evaporator and auxiliary refrigerant condenser.

The auxiliary dual mode heat exchanger 27 is connected via ducting, and valves 28, in the present case three way valves, with the compressor 8, the primary refrigerant evaporator 6 and the primary refrigerant condenser 7.

The auxiliary dual mode heat exchanger 27 acts as an auxiliary refrigerant evaporator if switch positions of the valves 28 are such that a ducting as indicated in FIG. 5 is obtained. In FIG. 5, inactive ducts are visualized in a shade of grey, whereas active ducts are visualized in black. The operational mode as possible with the ducting according to FIG. 5 can be selected in the initial operational phase in order to speed-up the heat-up process.

In a later operational stage, when the problem of overheating arises, the auxiliary dual mode heat exchanger 27 can be used as an auxiliary refrigerant condenser, in order to remove excess heat. The ducting required for operating the auxiliary dual mode heat exchanger 27 as auxiliary refrigerant condenser is indicated in FIG. 6 where inactive ducts are visualized in a shade of grey, whereas active ducts are visualized in black.

In case of a single auxiliary dual mode heat exchanger 27 with commutator or in case of separated auxiliary condenser and auxiliary evaporator, a control unit, in particular the refrigerant cycle control unit 20, may switch from one mode to another or activate/deactivate the fan of the auxiliary refrigerant condenser and auxiliary refrigerant evaporator in response of some certain parameter:
temperature/pressure of the refrigerant,
temperature/humidity of the process air 4,
temperature of the ambient air where the auxiliary evaporator is arranged,
temperature difference between the ambient air where the auxiliary evaporator is arranged and refrigerant temperature (preferably detected near or at the primary evaporator)

As it can be seen, providing an auxiliary dual mode heat exchanger 27 gives the same advantages, from a functional viewpoint, as the configuration in which both an auxiliary refrigerant evaporator 16 and condenser 17 are provided, but additionally provides the possibility to save space and components since only one heat exchanger can be installed at the dryer. It shall be mentioned, that at least one fan comparable to the first 18 and second fan 19 can be provided, and which may be adapted to impinge respective air streams at the dual mode heat exchanger 27, preferably a single fan can be provided.

FIG. 7 shows an arrangement of selected components of the heat pump tumble dryer. In more detail, an auxiliary evaporator 16, an auxiliary fan 18 and a motor 25 of the heat pump tumble dryer are shown, which are arranged in series in the present case.

The auxiliary fan 18 is arranged between the motor 25 and the auxiliary refrigerant evaporator 16. The auxiliary fan 18 can be operated such that an auxiliary fan airflow from the motor 25 towards the auxiliary refrigerant evaporator 16 is generated.

During operation of the motor 25 waste heat is generated. Such waste heat will lead to elevated temperatures within the cabinet of the heat pump tumble dryer. In particular, air guided, blown or as in the present case sucked through regions with waste heat sources is heated up and impinged at the auxiliary refrigerant evaporator 16. In this case, the initial heating up time of the auxiliary refrigerant evaporator 16 can be greatly reduced and energy consumption can be reduced. Note that other arrangements of the motor 25, or other waste heat generating elements or components, the auxiliary fan 18 and the auxiliary refrigerant evaporator 16 are conceivable, such as for example arrangements as mentioned further above.

In FIG. 7 there is further shown a temperature sensor 23 which is arranged between the motor 25 and the auxiliary fan 18. The temperature sensor 23 is provided for determining an air temperature neat or at the motor 25 and the auxiliary fan 18. The temperature detected by the temperature sensor 23 can be used to control the auxiliary fan 18, as described further above.

Note that there may be provided more than one temperature sensor, which temperature sensors may be placed in different locations, such for example near or at the at least one auxiliary refrigerant evaporator 16, between the auxiliary refrigerant evaporator 16 and auxiliary fan 18, between waste heat generating components, such as the motor or electric components of the heat pump tumble dryer, and the at least one auxiliary refrigerant evaporator 16.

It shall further be noted, that the mutual arrangement of motor 25, auxiliary fan 18 and auxiliary refrigerant evaporator 16 may differ from the arrangement shown in FIG. 7 such that alternative or other locations for the temperature sensors are also conceivable.

In all, it can be seen, that the heat pump tumble dryer and respective methods of operating the same make it possible to operate a tumble dryer more effectively, in particular in view of energetic aspects.

### LIST OF REFERENCE NUMERALS

1 heat pump tumble dryer
2 drying drum
3 clothing
4 process air
5 heat pump unit
6 primary refrigerant evaporator
7 primary refrigerant condenser
8 compressor
9 primary refrigerant evaporator outlet
10 compressor inlet
11 compressor outlet
12 primary refrigerant condenser inlet
13 primary refrigerant condenser outlet
14 throttling element
15 primary refrigerant evaporator inlet
16 auxiliary refrigerant evaporator
17 auxiliary refrigerant condenser
18 first/auxiliary fan
19 second/auxiliary fan
20 refrigerant cycle control unit
21-24 first to fourth temperature sensor
25 motor
26 third fan
27 dual mode heat exchanger
28 valve
Tᵢ inlet temperature
Tₒ outlet temperature
Tₐ ambient air temperature

1. A heat pump dryer comprising a process air circuit and a heat pump unit having a primary refrigerant evaporator for cooling process air and a primary refrigerant condenser for heating process air, characterized by comprising either
an auxiliary refrigerant evaporator connected between the primary refrigerant evaporator and a compressor of the heat pump unit and an auxiliary refrigerant condenser connected between the primary refrigerant condenser and refrigerant expansion means, both arranged outside the process air circuit or
an auxiliary heat exchanger arranged outside the process air circuit wherein the auxiliary heat exchanger is a dual mode heat exchanger operable in refrigerant evaporator mode or in refrigerant condenser mode.

2. A heat pump dryer according to claim 1, comprising at least one auxiliary fan adapted and arranged to impinge an airflow at the auxiliary refrigerant evaporator and at least one auxiliary fan adapted and arranged to impinge an airflow at the auxiliary refrigerant condenser and further comprising at least one sensor for detecting at least one physical parameter of the refrigerant and/or the process air and/or the ambient air around the location where the auxiliary refrigerant evaporator and/or the auxiliary refrigerant condenser are/is arranged and a control unit adapted and designed for evaluating the time development of the physical parameter and adapted and designed for activating/deactivating said auxiliary fans according to the evaluation of the time development of the physical parameter.

3. A heat pump dryer according to claim 1, wherein the physical parameter is at least one of a refrigerant temperature, refrigerant pressure, process air temperature, process air humidity, and temperature of the ambient air around location where the auxiliary refrigerant evaporator and/or the auxiliary refrigerant condenser are/is arranged.

4. A heat pump dryer according to claim 3, wherein the refrigerant temperature is detected at the outlet of the primary refrigerant evaporator and/or at the outlet of the primary refrigerant condenser, the process air temperature is detected at the inlet of a drying chamber of the heat pump dryer, and the ambient air temperature is detected near or at the auxiliary refrigerant evaporator and/or near at the auxiliary refrigerant condenser.

5. A heat pump dryer according to claim 1, wherein the control unit is adapted to deactivate the auxiliary fan of the auxiliary refrigerant evaporator in an intermediate operational stage between a first and second operational stage, and the control unit is adapted to activate the auxiliary fan of the auxiliary refrigerant condenser in a second operational stage.

6. A heat pump dryer according to claim 1, wherein the control unit is adapted to activate/deactivate the auxiliary fan of the auxiliary refrigerant evaporator according to the temperature difference between refrigerant and the ambient air around the location where the auxiliary refrigerant evaporator is arranged.

7. A heat pump dryer according to claim 1, comprising at least one sensor for detecting at least one physical parameter of the refrigerant and/or the process air and/or the ambient air around the location where the auxiliary heat exchanger is arranged and a control unit adapted and designed for evaluating the time development of the physical parameter and adapted and designed for switching the auxiliary heat exchanger between the evaporator mode and the condenser mode according to the evaluation of the time development of the physical parameter, wherein preferably the physical parameter is at least one of a refrigerant temperature, refrigerant pressure, process air temperature, process air humidity, and temperature of the ambient air around the location where the auxiliary heat exchanger is arranged.

8. A heat pump dryer according to claim 7, wherein the refrigerant temperature is detected at the outlet of the primary refrigerant evaporator
and/or at the outlet of the a primary refrigerant condenser, the process air temperature is detected at the inlet of a drying chamber of the heat pump tumble dryer, and the air temperature is detected near or at the auxiliary heat exchanger.

9. A heat pump dryer according to claim 1, wherein the control unit is adapted to switch the auxiliary heat exchanger between evaporator mode and condenser mode in response of at least one of
a temperature and/or pressure of the refrigerant,
a temperature and/or humidity of the process air,
a temperature of ambient air near or at the auxiliary heat exchanger, and
a temperature difference between ambient air temperature near or at the auxiliary heat exchanger and refrigerant temperature, detected near or at the primary evaporator.

10. A heat pump dryer according to claim 1, comprising commutating means; comprising one or more valves, adapted to switch the auxiliary heat exchanger between evaporator mode and condenser mode.

11. A heat pump dryer according to claim 10, wherein the control unit is adapted to operate the commutating means according to an evaluation of a time development of the physical parameter.

12. A heat pump dryer according to claim 1, wherein the auxiliary heat exchanger is connected via ducting, and valves, with the primary refrigerant evaporator, the primary refrigerant condenser and a compressor.

13. A heat pump dryer according to claim 1, comprising at least one auxiliary fan adapted and arranged to impinge an airflow at the auxiliary heat exchanger and further comprising at least one sensor for detecting at least one physical parameter of the refrigerant and/or the process air and/or the ambient air of the location where the auxiliary heat exchanger is arranged, and a control unit adapted and designed for evaluating a time development of the physical parameter and adapted and designed for activating/deactivating said auxiliary fan according to the evaluation of the time development of the physical parameter, wherein the physical parameter is at least one of a refrigerant temperature, refrigerant pressure, process air temperature, process air humidity, and ambient air temperature of the location where the auxiliary heat exchanger is arranged.

14. A heat pump dryer according to claim 1 wherein the control unit activates/deactivates the auxiliary fan of the auxiliary heat exchanger according to at least one of
a temperature difference between refrigerant and air near or at the auxiliary refrigerant evaporator or auxiliary refrigerant condenser, the refrigerant temperature preferably being measured near or at the primary refrigerant evaporator and
an air temperature near or at the auxiliary refrigerant evaporator, auxiliary refrigerant condenser, auxiliary fan and/or a waste heat generating component of the heat pump tumble dryer;
a temperature of the refrigerant and/or a pressure of the refrigerant, both preferably measured near or at a refrigerant outlet of the primary evaporator or primary condenser;
a temperature of refrigerant near or at an refrigerant outlet or inlet of the auxiliary refrigerant evaporator or auxiliary refrigerant condenser,
a temperature difference between refrigerant and air near or at the auxiliary refrigerant evaporator and,
a temperature of the process air and/or humidity of the process air, bath near or at a process air inlet of a drum of the heat pump tumble dryer.

15. A heat pump dryer according to claim 1 wherein the control unit activates the auxiliary an of the auxiliary heat exchanger if the temperature of the respective fan air stream is at least above the temperature of the refrigerant at the refrigerant outlet of the primary refrigerant evaporator or inlet of the auxiliary heat exchanger, and wherein the control unit deactivates the auxiliary fan of the auxiliary heat exchanger if the temperature of the fan air stream is at least below the temperature of the refrigerant at the refrigerant outlet of the primary refrigerant evaporator.
